(19) United States
(12) Patent Application Publication
(10) Pub. No.: US 2006/0209653 A1
(43) Pub. Date: Sep. 21, 2006

(54) Optical data recording method and optical disc drive

(76) Inventors: Mamoru Shoji, Sakai-shi (JP); Takashi Ishida, Yawata-shi (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/553,512

(22) PCT Filed: Mar. 24, 2004
(86) PCT No.: PCT/JP04/04096

§ 371 Date: Oct. 18, 2005

(30) Foreign Application Priority Data
Apr. 21, 2003 (JP) 2003-115548

(51) Int. Cl. G11B 7/00

(52) U.S. Cl. 369/53.24

(57) ABSTRACT

An optical data writing method according to the present invention is designed to write user data optically on an optical disk by dividing the user data into a number of blocks, each being made up of a plurality of sectors, and by adding an error correction code to each block. The method includes the steps of: writing a first set of data, including data representing a first content, on a track on the optical disk; and writing a second set of data, including data representing a second content, onto the track such that an unrecorded area, where no data is stored, is left between respective areas where the first and second sets of data have been written.

### TECHNICAL FIELD

The present invention relates to an optical data writing method for writing data on an optical disk by irradiating the optical disk with a laser beam and also relates to an optical disk drive.

### BACKGROUND ART

Recordable optical disks have been the object of much attention as media that can store a huge amount of data such as video data. And research and development has been carried on to increase the capacities of those recordable optical disks and store video of higher quality there for a longer time.

Those recordable optical disks are classifiable into disks on which data can be rewritten a number of times (which will be referred to herein as “rewritable optical disks”) and disks on which data can be added but may be written only once (which will be referred to herein as “write-once optical disks”).

FIG. 1A schematically illustrates the structure of a conventional write-once optical disk. The optical disk 601 includes a spiral track 602, on which recording marks 604, obtained by modulating data to be written, are made. For example, data representing a first content 603 to be recorded is modulated, thereby leaving recording marks 604 on the optical disk 601.

If an unrecorded area is still left even after the first content 603 has been recorded, then data may be further written to the optical disk 601. In writing such data, however, no unrecorded area should be left between the recording marks representing the first content 603 and recording marks representing the content to be further written in order to make the series of recording marks continuous on the track and to read the data stored properly. As used herein, the “unrecorded area” refers to an area in which no recording marks are present and which is even longer than the longest one of the marks and spaces obtained by modulating the data to be written.

According to a first conventional writing method, to prevent such an unrecorded area from being left between the recorded area and the additional storage area, the write operation is carried out such that the end of the recording marks 604 representing the first content 603 is overlapped by the beginning of the recording marks 606 representing a second content 605 as shown in FIG. 1B. As can be seen from FIG. 1B, the recording marks are superposed one upon the other and no marks in proper shapes can be left in the area 607. For that reason, dummy data may be written on that area 607.

On the other hand, according to a second conventional writing method, the two recording marks are made continuously so as to leave no unrecorded area between the end of the recording marks 604 representing the first content 603 and the beginning of the recording marks 606 representing the second content 605 as shown in FIG. 1C.

According to the first method, however, the recording marks are written twice on the same area 607. That is to say, since the area 607 is exposed to an excessive amount of laser beam, the track is likely to be damaged. As a result, when the written data is read out from such an optical disk, the focus servo and tracking servo often lose their stability. Particularly if the first and second contents have been written by using different recorders, then the damage done on the track may be significant due to the difference in writing conditions.

Meanwhile, according to the second method, one of the recording marks representing the second content is left adjacent to one of the recording marks representing the first content. Accordingly, in recording the second content, the end 609 of the recording marks 604 is subject to the heat generated when the recording marks 606 are made. As a result, the recording marks at the end 609 may be deformed or destroyed, which is a problem.

The higher the storage densities of optical disks, the narrower the track pitches and track widths. Then, such a problem will be even more likely to occur in the near future.

### DISCLOSURE OF INVENTION

In order to overcome at least one of the problems described above, an object of the present invention is to provide an optical data writing method and optical disk drive for performing a read operation with good stability even if a write-once operation has been performed.

An optical data writing method according to the present invention is designed to write user data optically on an optical disk by dividing the user data into a number of blocks, each being made up of a plurality of sectors, and by adding an error correction code to each block. The method includes the steps of: writing a first set of data, including data representing a first content, on a track on the optical disk; and writing a second set of data, including data representing a second content, onto the track such that an unrecorded area, where no data is stored, is left between respective areas where the first and second sets of data have been written.

In one preferred embodiment, the track on the optical disk includes no prepit areas defining addresses.

In another preferred embodiment, the unrecorded area is at least as long as one sector.

In another preferred embodiment, the end of the data representing the first content and/or the beginning of the data representing the second content includes dummy data.

In another preferred embodiment, the first set of data includes dummy data after the data representing the first content.

In another preferred embodiment, the second set of data includes dummy data before the data representing the second content.

In another preferred embodiment, a gap as long as one block is provided between the respective areas in which the data representing the first content and the data representing the second content have been written.

In another preferred embodiment, each of the first and second sets of data is divided into a plurality of sectors, which are spaced apart from each other by linking areas of the same length, and a gap as long as one linking area is provided between the respective areas where the data representing the first content and the data representing the second content have been written.

In another preferred embodiment, the dummy data defines a phase-locking pattern.

In another preferred embodiment, the first or second set of data is written by irradiating the unrecorded area with light having erasing power.

A computer-readable storage medium according to the present invention has stored thereon a program that is defined so as to make a computer execute respective processing steps of one of the optical data writing methods described above.

An optical disk drive according to the present invention is designed to write user data optically on an optical disk by dividing the user data into a number of blocks, each being made up of a plurality of sectors, and by adding an error correction code to each block. The drive includes: a motor for rotating and driving the optical disk; an optical head for irradiating the optical disk with a light beam to write data thereon; a servo control section for controlling the rotational velocity of the motor and a spot made by the light beam; and a light beam control section for controlling the intensity of the light beam. The servo control section and the light beam control section control the optical disk and the light beam so as to write a first set of data, including data representing a first content, on a track on the optical disk and then write a second set of data, including data representing a second content, onto the track such that an unrecorded area, where no data is stored, is left between respective areas where the first and second sets of data have been written.

In one preferred embodiment, the track on the optical disk includes no prepit areas defining addresses.

In another preferred embodiment, the unrecorded area is at least as long as one sector.

An optical disk according to the present invention is a disk, on a track of which user data has been written optically by dividing the user data into a number of blocks, each being made up of a plurality of sectors, and by adding an error correction code to each block. An unrecorded area, where no data has been written yet, is formed between an area where a first set of data, including data representing a first content, is stored and an area where a second set of data, including data representing a second content, is written.

In one preferred embodiment, the track includes no prepit areas defining addresses.

In another preferred embodiment, the unrecorded area is at least as long as one sector.

### BRIEF DESCRIPTION OF DRAWINGS

FIGS. 1A, 1B and 1C schematically illustrate a conventional method to add data onto an optical disk.

FIG. 2 is a block diagram illustrating a preferred embodiment of an optical disk drive according to the present invention.

FIGS. 3A and 3B schematically illustrate a first preferred embodiment of a writing method according to the present invention.

FIG. 4 schematically shows a structure of data to be written on an optical disk.

FIG. 5 schematically shows another structure of data to be written on an optical disk.

FIG. 6 schematically shows still another structure of data to be written on an optical disk.

FIGS. 7A and 7B schematically illustrate the first preferred embodiment of the writing method of the present invention.

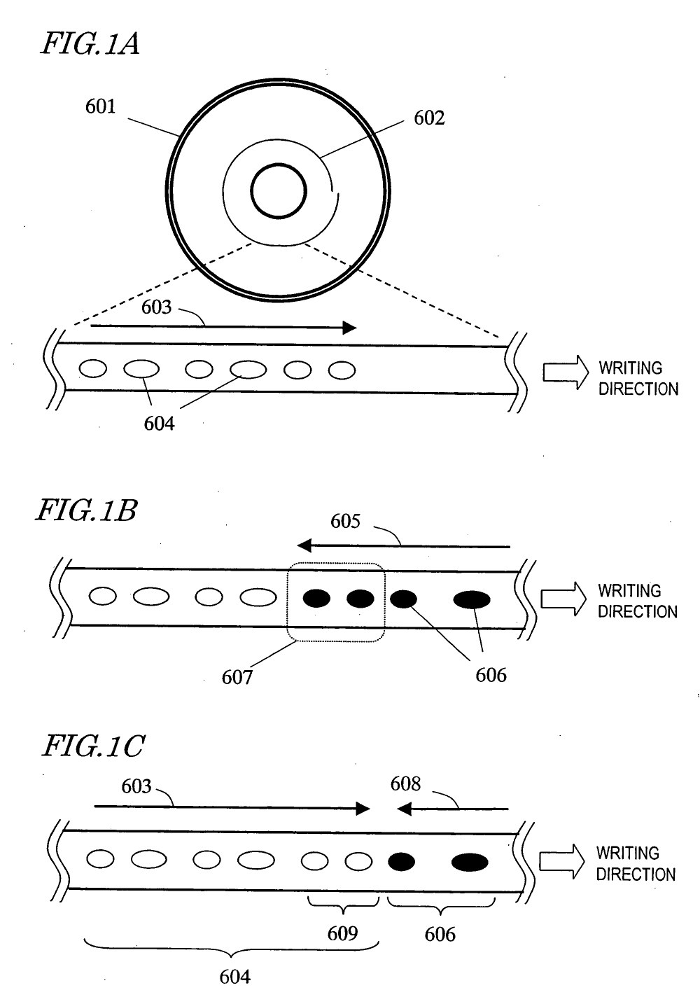

### BEST MODE FOR CARRYING OUT THE INVENTION

### Embodiment 1

Hereinafter, a first preferred embodiment of an optical disk drive and optical data writing method according to the present invention will be described. The present invention is applicable to an optical disk drive and optical data writing method for making a recording mark by irradiating an optical disk, including a storage layer, with an infrared ray, visible radiation, an ultraviolet ray or light with any of various wavelengths (which may fall within the range of 635 nm to 830 nm or may be 405 nm) and by changing the reflectance of the irradiated portion.

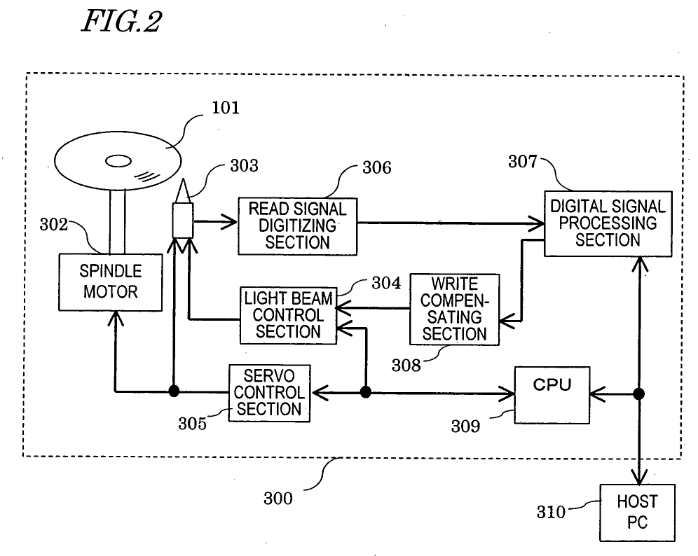

FIG. 2 is a block diagram illustrating a configuration for an optical disk drive 300 according to this preferred embodiment. The optical disk drive 300 includes a spindle motor 302, an optical head 303, a light beam control section 304, a servo control section 305, a read signal digitizing section 306, a digital signal processing section 307, a write compensating section 308 and a CPU 309.

The spindle motor 302 rotates and drives an optical disk 101 at a predetermined rotational velocity under the control of the servo control section 305.

The servo control section 305 controls the tracking control and focus control operations such that the light beam emitted from the optical head 303 follows the track on the optical disk 101 and maintains a predetermined converging state on the track.

In performing a read operation, the optical head 303 irradiates the optical disk 101 with a light beam and converts the light reflected from the optical disk 101 into an electrical signal, thereby outputting it as a read signal. The read signal digitizing section 306 amplifies and digitizes the read signal supplied from the optical head 303, thereby generating a digital signal. Also, by using a built-in PLL (not shown), the read signal digitizing section 306 generates a clock signal synchronized with the digital signal.

The digital signal processing section 307 processes the digital signal. If address information is included in the digital signal, then the digital signal processing section 307 subjects the digital signal to a predetermined demodulation process, thereby extracting an address from it. On the other hand, if user data is included in the digital signal, then the digital signal processing section 307 subjects the digital signal to a predetermined demodulation process and error correction process, thereby generating read data. The address information and read data thus obtained are output to a host PC 310.

In writing data on the optical disk 101, the digital signal processing section 307 receives the data to be written from the host PC 310. Also, the digital signal processing section 307 adds an error correction code to the write data received and subjects it to a predetermined modulation process, thereby generating modulated data.

The modulated data generated is converted by the write compensating section 308 into optically modulated data consisting of pulse trains. The write compensating section 308 also finely adjusts the pulse widths of the optically modulated data, thereby converting it into a write pulse signal, which contributes to making a recording mark easily.

The light beam control section 304 controls the optical head 303 such that a light beam corresponding to the write pulse signal is output in accordance with the instruction of the CPU 309. In this case, the CPU 309 instructs the servo control section 305 to control the spot of the light beam that has been emitted from the optical head 303 and the rotational velocity of the optical disk such that the light beam is incident on a predetermined location on the optical disk.

The host PC 310 includes a computer (not shown), an application program (not shown) and an operating system (not shown) and instructs the optical disk drive 300 to perform a read or write operation.

If a first set of data, including data representing a first content, has been written on a track on an optical disk and if a second set of data, including data representing a second content, is further written onto that track, the optical disk drive 300 writes the second set of data such that an unrecorded area is left between the respective areas where the first and second sets of data have been written. Hereinafter, the optical data writing method performed by this optical disk drive 300 will be described in detail.

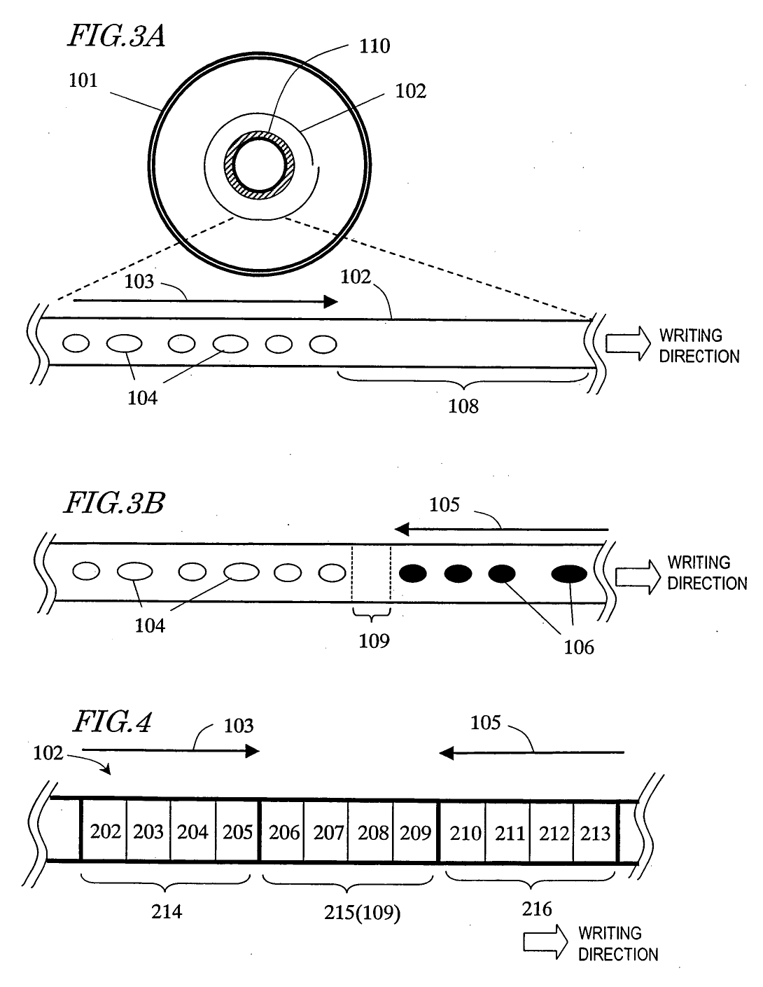

FIG. 3A schematically illustrates the structure of the optical disk 101 on which a first content 103 has been written. The optical disk 101 includes a spiral track 102 on which recording marks, representing data to be written, are made. The optical disk 101 is a write-once disk. As used herein, the “write-once disk” refers to a disk that allows the user to write data only once on an unrecorded area. However, as long as the unrecorded area is still left, the operation of writing data onto that unrecorded area may be performed in multiple stages. That is to say, the data does not have to be written on the entire disk at a time.

On the track 102, recording marks 104, representing data representing the first content 103, have already been left. Also, an unrecorded area 108 where no recording marks have been made yet is still left on the track 102 and extends from the last one of the recording marks 104 in the writing direction. Since data is written on a track by making those recording marks on the track, “to make a recording mark” will be regarded herein as synonymous with “to write data”.

An information storage management area 110 is provided as the innermost area on the optical disk 101. The information management area 110 includes a power calibration area for calibrating the laser power during a write operation and a storage management area for managing the storage area.

In writing the second content 105 onto the optical disk 101 in such a state, an unrecorded area 109 on which no recording marks 109 have been made yet is provided between the last one of the recording marks 104 representing the first content 103 and the beginning of the second content 105 as shown in FIG. 3B. It should be noted that FIG. 3B schematically illustrates the structure of the track and does not show the recording marks and unrecorded area 109 in accordance with their actual size relationship.

By providing the unrecorded area 109 in this manner, the recording marks 104 representing the first content 103 and the recording marks 106 representing the second content 105 never overlap with each other. Thus, it is possible to avoid the unwanted situation where the track is deformed due to the exposure to an excessive amount of radiation. Consequently, the servo operation never loses stability at the boundary portion and the read/write operations can always be performed with good stability.

However, the recording marks 104 are preferably made continuously within the area in which the data representing the first content 103 should be stored, and the recording marks 106 are preferably made continuously within the area in which the data representing the second content 105 should be stored. In that case, the unrecorded area will indicate the linking portion between the contents, and the gap between the contents can be detected quickly when data is read out from the optical disk 101.

FIG. 4 schematically shows the structures of the first content 103, second content 105 and unrecorded area 215 to be stored on the track 102 on the optical disk 101. Data is written on the track 102 on a sector-by-sector basis and error correction process is performed on each block consisting of a plurality of sectors. Address information representing a relative position on the track 102 is also given on a block-by-block basis.

The address information may be either defined as data by the recording marks or superposed on the track wobble. However, the sectors preferably include no header areas in which the address is defined in advance by prepits as in a DVD-RAM, for example. Since no data may usually be written on such a header area, the respective sectors will be substantially separated by those header areas. Thus, even if no such unrecorded areas are provided, no problems due to the deformation of the tracks or recording marks will arise.

The first content 103 ends with a block 214 including sectors 202 to 205, while the second content 105 begins with a block 216 including sectors 210 to 213. The unrecorded area 109 is preferably provided on a block basis and may include one block 215, for example. This block 215 includes sectors 206 to 209. Since no recording marks are made on the block 215, it is actually impossible to distinguish the sectors 206 to 209. However, an area, which is long enough to store data corresponding to the sectors 206 to 209, is secured along the track 102.

Hereinafter, it will be described with reference to FIGS. 2 and 4 how the optical disk drive 300 performs read and write operations. A program or firmware that makes the CPU 309 control the respective components of the optical disk drive 300 in the procedure to be described below may be stored in a computer-readable storage medium such as an EEPROM, a ROM, a RAM, a hard disk or a magnetic recording medium (none of which is shown).

First, recording marks representing the first content are made on the track 102 on the optical disk 101 by a conventional method. While the first content is being written, the laser power is calibrated in the information management area 110. After the first content has been written, information about the first content (e.g., the end address thereof) may be stored in the information management area 110.

Next, the second content is written on the optical disk 101. The optical disk drive 300 that writes the second content may or may not be the same as the optical disk drive 300 that has written the first content.

When the host PC 310 requests the CPU 309 to write the second content, the servo control section 305 moves the optical head 303 to around a sector having the address requested. In this case, if the optical disk drive that has written the first content is different from the optical disk drive that is going to write the second content, then the laser power is calibrated in the information management area 110 before the second content is written.

Meanwhile, the digital signal processing section 307 modulates the second content and the write compensating section 308 finely adjusts the widths and positions of the pulse signal that has been modulated so as to make appropriate recording marks. To write the second content, the location where the write operation should be started needs to be detected accurately. For that purpose, the optical disk 101 is irradiated with the light and the optical head 303 and read signal digitizing section 306 acquires the address of the area where the first content has been written by using the digital signal obtained from the reflected light. More specifically, the address reading process is started and the sectors 202, 203, 204 and 205 are read, thereby detecting the block address by the wobble information. As a result, the last block 214 in which the first content 103 has been written can be located.

The CPU 309 reads the address of the block 215 and starts writing data on the block 216 from the sector 210 such that the block 215 to be the unrecorded area 109 is left unrecorded after the last block of the first content 103 and that recording marks representing the second content 105 start being made on the block 216 that follows the block 215.

In this case, the light beam output from the optical head 303 is controlled by the light beam control section 304 to a predetermined power value that has been instructed by the CPU 309. Also, by changing the radiation power of the light beam in accordance with the data generated by the write compensating section 308, the optical characteristic of the material of the storage layer is changed, thereby making predetermined recording marks on the track 102. After data has been written on the sector 210, predetermined data is sequentially written on the sectors 211, 212 and 213 to finish writing the second content 105. When the second content 105 has been written, information about the address of the second content 105 may be written on the information management area.

In reading the optical disk 101, the optical disk drive 300 irradiates the optical disk 101 with a light beam and makes the optical head 303 generate a read signal from the light that has been reflected from the optical disk 101 as in reading a normal read-only optical disk. The read signal thus obtained is amplified and digitized by the read signal digitizing section 306, thereby generating a digital signal. In the meantime, a clock signal synchronized with the digital signal is generated by the internal PLL (not shown).

The digital signal obtained in this manner has a no-data portion, corresponding to the unrecorded area 109 of the optical disk 101, between the data representing the first content and the data representing the second content. For that reason, if this optical disk were read by the same signal processing as in reading a normal read-only optical disk, then the unrecorded area might be sensed as a lead-out area by mistake and the read operation might end without reading the data representing the second content at all.

To avoid such an error, the optical disk drive 300 maintains a phase-locked state by using the clock signal, generated by the PLL, during the interval after the first content has been read through and before the data representing the second content is retrieved. If normal data is temporarily unavailable due to deposition of dust on an optical disk, for example, an optical disk drive usually has the function of retaining the previous data until the normal data becomes available. Accordingly, by modifying such a function so that the previous data is retained and the digital signal is kept synchronized during the interval corresponding to the unrecorded area, the optical disk of the present invention can be read appropriately.

In this preferred embodiment, a phase-locking pattern may be provided at the beginning of a block representing the content. By recording the phase-locking pattern, the PLL can accomplish phase locking quickly and the read operation can be performed with good stability even if there is an unrecorded area.

Specifically, as shown in FIG. 5, phase-locking patterns 404, 405, 407, 408 and 409 may be provided at the respective tops of blocks 401 and 214, representing a portion of the first content 103, and blocks 216, 204 and 403 representing a portion of the second content 105. The phase-locking patterns may be provided as an alternation of 4T marks and 4T spaces, an alternation of 3T marks and 3T spaces, an alternation of 2T marks and 2T spaces, or an alternation of 5T marks and 5T spaces, for example.

By providing such phase-locking patterns, the optical disk drive 300 can retain the previous data during the interval corresponding to the unrecorded area 215 after having read data from the block 214 of the first content 103. And in reading data from the block 216 of the second content 105, the optical disk drive 300 can synchronize the digital signal, generated by processing the data of the second content 105, quickly since the phase-locking pattern 216 is provided at the top of the block 216.

Also, the phase-locking patterns 404, 405, 408 and 409 provided for the blocks 401, 214, 402 and 403, respectively, can contribute to recovering the stability of the phase-locked loop quickly even if the PLL has lost some of the stability due to a scratch on the track 102, for example.

In addition, another phase-locking pattern 406 may be provided at the end of the last block 214 of the first content 103. In that case, the phase-locking patterns 406 and 407 are arranged before and after the block 215 representing the unrecorded area. As a result, in the digital signal, no-signal portion corresponding to the block 215 is interposed between two phase-locking signal components, thus further increasing the stability of the digital signal.

It should be noted that the phase-locking patterns 404, 405, etc. provided at the top of the blocks, the pattern 406 provided at the end of the first content, and the phase-locking pattern 407 provided at the beginning of the content may have mutually different lengths. Among other things, the phase-locking pattern 407 provided at the beginning of the second content 105 is preferably longer than the phase-locking patterns of the other blocks because the pattern 407 is preceded by the unrecorded area.

Furthermore, the pattern provided at the end of the first content 103 does not have to be a phase-locking pattern. The optical disk drive can also sense the end of the first content if the pattern provided at the end of the second content 103 is different from the other patterns.

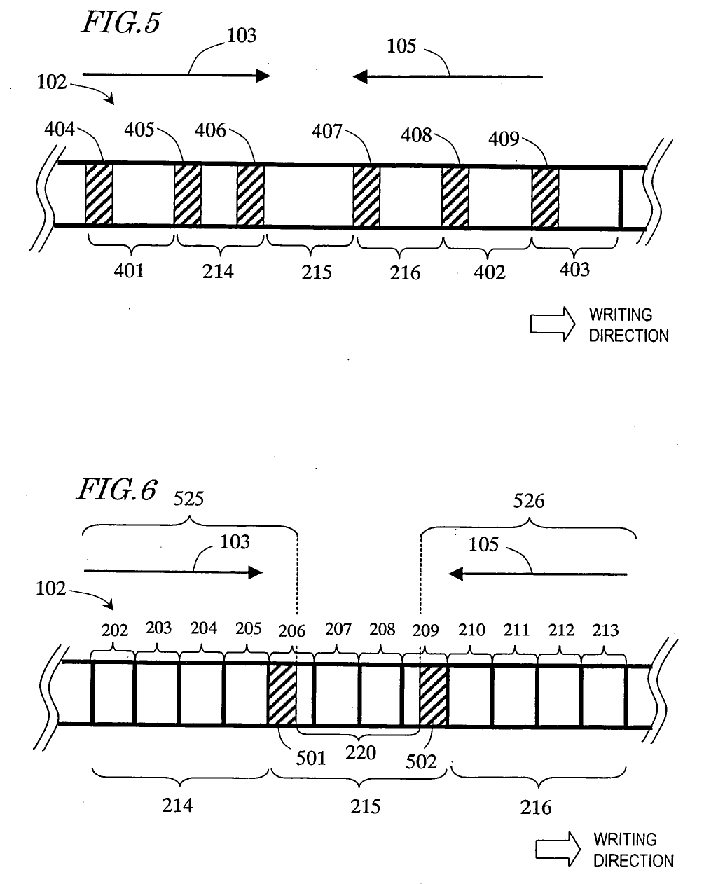

The optical disk described above includes an unrecorded area that is as long as one block. However, the unrecorded area may be shorter than one block. As shown in FIG. 6, the block 215, sandwiched between the last block 214 of the first content 103 and the first block 216 of the second content 105, includes an unrecorded area 220 and dummy data areas 501 and 502 on which recording marks, representing arbitrary dummy data, have been written. As used herein, the “dummy data” is data other than user data and address data. The dummy data area 501 is adjacent to the last block 214 of the first content 103, while the dummy data area 502 is adjacent to the first block 215 of the second content 105.

In order to prevent making of the recording marks in the dummy data areas 501 and 502 from affecting the recording marks that form the first and second contents 103 and 105, the recording marks are preferably written in the dummy data area 501 right after the first content 103 has been written fully. Also, the recording marks are preferably left in the dummy area 502 just before the second content 105 starts to be written.

That is to say, a first set of data 525, including the data representing the first content 103 and the dummy data to be written onto the dummy data area 501, is written onto the track 102 at a time. Next, a second set of data 526, including the dummy data to be written onto the dummy data area 502 and the data representing the second content 105, is written onto the track 102 at a time such that the unrecorded area 220 is left between the respective areas where the first and second sets of data have been written. As a result, it is possible to prevent the dummy data areas 501 and 502 from affecting the recording marks that form the first and second contents 103 and 105 or the overwritten recording marks from deforming the track shape.

The dummy data area 501 may form either all or just a part of the sector 206. Likewise, the dummy data area 502 may form either all or just a part of the sector 209. Also, if an unrecorded area that is at least as long as one sector is left, each dummy area may be equal to or longer than two sectors. Furthermore, unless the recording end point of the dummy area 501 overlaps with the recording start point of the dummy area 502, the unrecorded area 220 may even be shorter than one sector.

The dummy data areas 501 and 502 are included in the same block 215. However, data for the dummy data area 501 and data for the dummy data area 502 are written at mutually different times. That is why in writing data on the dummy data area 502, first, the data is preferably read from the dummy data area 501 and then an error correction code is preferably added to the data that has been written on the dummy data area 501 and to the data that is going to be written on the dummy data area 502.

By providing the dummy data areas 501 and 502, the unrecorded area 220 between the two contents can be shortened and the PLL can keep operating with even more stability. A phase-locking pattern may be used as the dummy data. To stabilize the operation of the PLL, the dummy data area 501 is preferably longer than the dummy data area 502 that is adjacent to the second content 105.

In the preferred embodiment described above, an unrecorded area is provided between two contents. However, if no marks are recorded in the unrecorded area, the write operation may be performed with higher power than that used for a read operation. For example, the write operation may be performed with erasing power.

### Embodiment 2

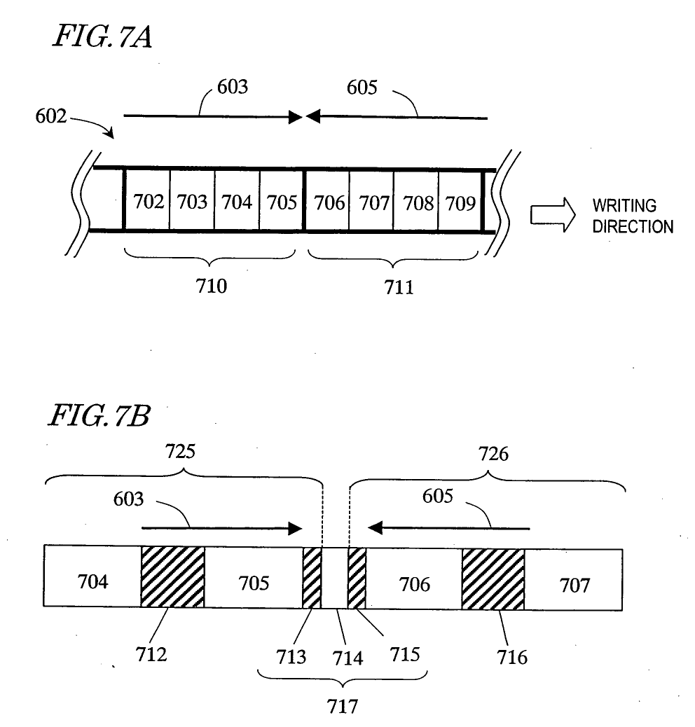

Hereinafter, a second preferred embodiment of the present invention will be described. FIGS. 7A and 7B schematically illustrate the structure of an optical disk on which a first content 603 and a second content 605 are stored. As in the first preferred embodiment described above, this optical disk is also a write-once disk and has a spiral track 602 on which recording marks, representing data to be stored, are made. An information management area is provided in an inside portion of the optical disk.

Each of the first and second contents 603 and 605 consists of a plurality of blocks, each of which includes a plurality of sectors. Linking areas of the same length are provided between those sectors.

For example, the first content 603 includes sectors 702 to 705 and the second content 605 includes sectors 706 to 709. A linking area 712 is provided between the sectors 704 and 705 and a linking area 716 is provided between the blocks 706 and 707.

A linking area 717 is provided between the last block 710 of the first content 603 and the first block 711 of the second content 605, i.e., between the sectors 705 and 706.

A predetermined signal has been written on the linking areas included in the first and second contents 603 and 605. For example, a phase-locking signal may have been written there. On the other hand, the linking area 717 between the first and second contents 603 and 605 includes dummy data areas 713 and 715 in which predetermined dummy data is stored and an unrecorded area 714 interposed between the dummy data areas 713 and 715.

The dummy data area 713 is adjacent to the sector 705 of the first content 603, while the dummy data area 715 is adjacent to the sector 706 of the second content 605. In the dummy data areas 713 and 715, data that can be easily detected and can be clearly distinguished from the user data (e.g., an iterative pattern with a single frequency, an iterative pattern with a unique period, or a pattern that is not used for writing user data) is preferably stored. By storing such easily detectable data in the dummy data areas 713 and 715, the boundary between the first and second contents 603 and 605 can be located easily.

By providing the unrecorded area 714 in this manner, the recording marks representing the first content 603 and the recording marks representing the second content 605 never overlap with each other. Thus, it is possible to avoid the unwanted situation where the track is deformed due to the exposure to an excessive amount of radiation. Consequently, the servo operation never loses stability at the boundary portion and the read/write operations can always be performed with good stability.

The data stored in the dummy data area 715 may be a phase-locking pattern. In that case, when a signal representing the second content is read, the PLL can accomplish phase locking by using the phase-locking pattern. As a result, the second content can be read with good stability.

Also, the signal written on the dummy data area 713 may be different from that written on the dummy data area 715. Then, the boundary between the first and second contents 603 and 605 can be located. Furthermore, by detecting both the dummy data areas 713 and 715 and the unrecorded area, the temporary absence of signals due to dust deposited on the optical disk, for example, and the unrecorded area in the boundary between the two contents can be distinguished from each other.

Optionally, the length of the signal written on the dummy data area 713 may be different from that of the signal written on the dummy data area 715. In that case, even if the same signal as that stored in the dummy data area 713 or 715 is included in the user data, the boundary between the two contents can still be detected by the difference between the lengths of signals that have been written on the dummy data areas 713 and 715.

If a phase-locking pattern is included in the data stored in the dummy data area 715, then the signal written on the dummy data area 715 is preferably longer than that written on the dummy data area 713. In that case, when a signal representing the second content is read, the PLL can accomplish phase locking by using the phase-locking pattern. As a result, the second content can be read with good stability.

The writing method of this preferred embodiment may be carried out by using the optical disk drive 300 that has already been described for the first preferred embodiment. Hereinafter, it will be described with reference to FIGS. 2, 7A and 7B how the optical disk drive 300 performs read and write operations.

First, a first set of data 725, including the data representing the first content 603 and the dummy data to be stored in the dummy data area 713, is written on the track 602 on the optical disk. More specifically, the data representing the first content 603 is written first, and the data for the dummy data area 603 is written immediately. In the meantime, the laser power is calibrated in the information management area to start the write operation. After the first content 603 has been written, information including the end address of the first content may be written on the information management area.

Next, a second set of data 726, including the dummy data to be stored in the dummy data area 715 and the data representing the second content 605, is written on the same track 602 on the optical disk. When the host PC 310 requests the CPU 309 to write the second set of data, the servo control section 305 moves the optical head 303 to around a sector having the address requested. In this case, if the optical disk drive that has written the first content 603 is different from the optical disk drive that is going to write the second content 605, then the laser power is calibrated in the information management area 110 before the second content is written.

Meanwhile, the digital signal processing section 307 modulates the second set of data and the write compensating section 308 finely adjusts the widths and positions of the pulse signal that has been modulated so as to make appropriate recording marks. To write the second set of data including the second content 605, the location where the write operation should be started needs to be detected accurately. For that purpose, the optical disk is irradiated with light and the optical head 303 and read signal digitizing section 306 acquire the address of the area where the first content 603 and the dummy data have been written by using the digital signal obtained from the reflected light. More specifically, the address reading process is started and the sectors 702, 703, 704 and 705 are read, thereby detecting the block address by the wobble information. As a result, the last block 710 in which the first content 603 has been written can be located.

The CPU 309 leaves the unrecorded area 714 unrecorded after the dummy data area 713, which was provided when the first content 603 was written, makes recording marks in the dummy data area 715 in the linking area 717, and then starts to write data on the sector 706 and so on.

In this case, the light beam output from the optical head 303 is controlled by the light beam control section 304 to a predetermined power value that has been instructed by the CPU 309. Also, by changing the radiation power of the light beam in accordance with the data generated by the write compensating section 308, the optical characteristic of the material of the storage layer is changed, thereby making predetermined recording marks on the track 602. After data has been written on the sector 706, the linking area 716 is defined and then predetermined data is sequentially written on the sector 707, linking area 716, sector 707 and so on to finish writing the second content 105. When the second content 105 has been written, information about the address of the second content 105 may be written on the information management area.

In reading the optical disk 101, the optical disk drive 300 irradiates the optical disk 101 with a light beam and makes the optical head 303 generate a read signal from the light that has been reflected from the optical disk 101 as in reading a normal read-only optical disk. The read signal thus obtained is amplified and digitized by the read signal digitizing section 306, thereby generating a digital signal. In the meantime, a clock signal synchronized with the digital signal is generated by the internal PLL (not shown). The digital signal obtained in this manner has a no-data portion, corresponding to the unrecorded area 109 of the optical disk 101, between the data representing the first content and the data representing the second content. For that reason, if this optical disk were read by the same signal processing as in reading a normal read-only optical disk, then the unrecorded area might be sensed as a lead-out area by mistake and the read operation might end without reading the data representing the second content at all.

To avoid such an error, the optical disk drive 300 maintains a phase-locked state by using the clock signal, generated by the PLL, during the interval after the first content has been read through and before the data representing the second content is retrieved as in the first preferred embodiment described above. If the dummy data stored in the dummy data areas 713 and 715 is a phase-locking pattern, then the no-signal portion corresponding to the unrecorded area 714 is sandwiched between two phase-locking signals. As a result, the read operation can be performed with more stability.

According to the preferred embodiments described above, an unrecorded area is provided between a series of two contents, thereby avoiding an unwanted situation where recording marks, representing the content that has already been written, or the track is deformed due to the heat generated while recording marks representing the content to be added are being made. Consequently, the written data can be read with good stability.

In particular, even when the two contents are written by two different drives, it is also possible to prevent the problem that the track is deformed due to the application of significantly excessive heat as the recording marks are overwritten one upon the other.

The writing method of this preferred embodiment is applicable particularly effectively to a write-once optical disk on which no data is supposed to be written on the same area again or every previous data is supposed to be destroyed whenever any data is written there for the second time. According to this writing method, no data is written on the same area again. That is why the writing conditions can be set without being limited by the conditions for write-once operation. As a result, the storage layer of an optical disk can be designed much more freely. Also, when an optical disk is disposed of, data may be overwritten there intentionally such that the servo operation will lose its stability and that no data can be read out anymore. In this manner, the optical disk can be thrown away with confidentiality maintained.

Also, no blocks but the first or last one of a content are adjacent to the unrecorded area. Thus, the gap between the contents can be detected easily.

Furthermore, as user data may be written on a block including the unrecorded area, the storage area can be used more effectively.

Besides, when dummy data is stored on a block including the unrecorded area, the length of the unrecorded area can be shortened and the PLL can operate with more stability. What is more, if the dummy data is a phase-locking pattern, then the PLL can operate with even more stability.

In the preferred embodiments described above, the unrecorded area is supposed to be provided between two continuous contents. However, the unrecorded area does not have to be provided between two contents. Similar effects are achieved even if the unrecorded area is provided in the boundary between two sets of data that were written by two different recorders or in the boundary between two sets of data that were written by the same drive on different occasions.

### INDUSTRIAL APPLICABILITY

The present invention can be used effectively in an optical disk drive that performs a write operation using light sources with various wavelengths, and is particularly effectively applicable to an optical disk drive that can write data on a write-once optical disk.

1. An optical data writing method for writing user data optically on an optical disk by dividing the user data into a number of blocks, each being made up of a plurality of sectors, and adding an error correction code to each said block, the method comprising the steps of:
writing a first set of data, including data representing a first content, on a track on the optical disk; and
writing a second set of data, including data representing a second content, onto the track such that an unrecorded area, where no data is stored, is left between respective areas where the first and second sets of data have been written.

2. The optical data writing method of claim 1, wherein the track on the optical disk includes no prepit areas defining addresses.

3. The optical data writing method of claim 1, wherein the unrecorded area is at least as long as one sector.

4. The optical data writing method of claim 1, wherein the end of the data representing the first content and/or the beginning of the data representing the second content includes dummy data.

5. The optical data writing method of claim 1, wherein the first set of data includes dummy data after the data representing the first content.

6. The optical data writing method of claim 1, wherein the second set of data includes dummy data before the data representing the second content.

7. The optical data writing method of claim 5, wherein a gap as long as one block is provided between the respective areas in which the data representing the first content and the data representing the second content have been written.

8. The optical data writing method of claim 5, wherein each of the first and second sets of data is divided into a plurality of sectors, which are spaced apart from each other by linking areas of the same length, and
wherein a gap as long as one linking area is provided between the respective areas where the data representing the first content and the data representing the second content have been written.

9. The optical data writing method of claim 4, wherein the dummy data defines a phase-locking pattern.

10. The optical data writing method of claim 1, wherein the first or second set of data is written by irradiating the unrecorded area with light having erasing power.

11. A computer-readable storage medium having stored thereon a program that is defined so as to make a computer execute respective processing steps of the optical data writing method of claim 1.

12. An optical disk drive for writing user data optically on an optical disk by dividing the user data into a number of blocks, each being made up of a plurality of sectors, and adding an error correction code to each said block, the drive comprising:
a motor for rotating and driving the optical disk;
an optical head for irradiating the optical disk with a light beam to write data thereon;
a servo control section for controlling the rotational velocity of the motor and a spot made by the light beam; and
a light beam control section for controlling the intensity of the light beam,
wherein the servo control section and the light beam control section control the optical disk and the light beam so as to write a first set of data, including data representing a first content, on a track on the optical disk and then write a second set of data, including data representing a second content, onto the track such that an unrecorded area, where no data is stored, is left between respective areas where the first and second sets of data have been written.

13. The optical disk drive of claim 12, wherein the track on the optical disk includes no prepit areas defining addresses.

14. The optical disk drive of claim 12, wherein the unrecorded area is at least as long as one sector.

15. An optical disk, on a track of which user data has been written optically by dividing the user data into a number of blocks, each being made up of a plurality of sectors, and adding an error correction code to each said block, wherein an unrecorded area, where no data is stored, is provided between an area where a first set of data, including data representing a first content, is stored and an area where a second set of data, including data representing a second content, is written.

16. The optical disk of claim 15, wherein the track includes no prepit areas defining addresses.

17. The optical disk of claim 15, wherein the unrecorded area is at least as long as one sector.

18. The optical data writing method of claim 6, wherein a gap as long as one block is provided between the respective areas in which the data representing the first content and the data representing the second content have been written.

19. The optical data writing method of claim 6, wherein each of the first and second sets of data is divided into a plurality of sectors, which are spaced apart from each other by linking areas of the same length, and
wherein a gap as long as one linking area is provided between the respective areas where the data representing the first content and the data representing the second content have been written.
